(19) United States
(12) Patent Application Publication
(10) Pub. No.: US 2006/0103168 A1
(43) Pub. Date: May 18, 2006

(54) Preform for hydroforming hydroforming method, and hydroformed product

(75) Inventors: Kazuto Ueno, Tokyo (JP); Satoru Majima, Hiratsuka-shi (JP); Takashi Haraoka, Tokyo (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/260,311

(22) Filed: Oct. 28, 2005

(30) Foreign Application Priority Data
Oct. 29, 2004 (JP) 2004-316599

(51) Int. Cl. B60J 7/00

(52) U.S. Cl. 296/187.02

(57) ABSTRACT

A preform including first and second outer members having peripheral borders overlapped and jointed for forming outer surfaces of a hollow section of a hydroformed product, and a reinforcement member disposed between the first and second outer members for forming a partition wall that substantially divides the hollow section. The outer members have sidewalls inclined relative to an overlapping surface of the first and second outer members, and summit parts surrounded by the sidewalls. The reinforcement member has one and the other ends jointed to areas which are to form the summit parts of the first and second outer members, and lateral edges which face peripheral areas of the first and second outer members which are to form the sidewalls.

### BACKGROUND OF THE INVENTION

1. Field of the Invention

The present invention relates to a preform for hydroforming, a hydroforming method, and a hydroformed product.

2. Description of the Related Art

A typical automobile body structural member such as a side member has a hollow structure for absorbing crash impact and is provided with internal reinforcement ribs for improving the strength. A typical hydroformed product to be used as the body structural member is made by feeding hydraulic pressure to the inside of a preform having two outer members and reinforcement members to cause an inflating deformation. See, e.g., publication Nos. of Unexamined Japanese Patent Applications, 2003-320960 and 2004-82142.

### SUMMARY OF THE INVENTION

However, reinforcement ribs formed by reinforcement members only locally or punctately support the hollow cross-section of a hydroformed product so that they provide only minor contributions to improvement of rigidity with reference to torsional bending, for example.

Moreover, a reinforcement rib having a cross-section formed in an X-shape supports only sidewalls extending in angles from the overlapping surface of the outer members. Therefore, it does not provide a sufficient improvement for the rigidity perpendicular to the mating surface of the outer members.

The object of the present invention is to provide a preform for hydroforming capable of improving the rigidity relative to torsional bending and the rigidity in the vertical direction of a hydroformed product, a hydroforming method for manufacturing a hydroformed product with the excellent rigidities relative to torsional bending and in the vertical direction, and a hydroformed product with the excellent rigidities relative to torsional bending and in the vertical direction.

More specifically, it is an object of the invention to provide a preform including first and second outer members having peripheral borders overlapped and jointed for forming outer surfaces of a hollow section of a hydroformed product, and a reinforcement member disposed between the first and second outer members for forming a partition wall that substantially divides the hollow section. The outer members have sidewalls inclined relative to an overlapping surface of the first and second outer members, and summit parts surrounded by the sidewalls. The reinforcement member has one and the other ends jointed to areas which are to form the summit parts of the first and second outer members, and lateral edges which face peripheral areas of the first and second outer members which are to form the sidewalls.

Another object of the invention is to provide a hydraulic forming method which includes a) disposing a preform inside forming dies having cavity surfaces which correspond to outer surface shapes of a hydroformed product, said preform with first and second outer members having peripheral borders overlapped and jointed for forming outer surfaces of a hollow section of a hydroformed product, and a reinforcement member disposed between the first and second outer members for forming a partition wall that substantially divides the hollow section, in which the outer members have sidewalls inclined relative to an overlapping surface of the first and second outer members, and summit parts surrounded by the sidewalls, in which the reinforcement member has one and other ends jointed to areas which are to form the summit parts of the first and second outer members, and lateral edges which face peripheral areas of the first and second outer members which are to form the sidewalls, b) introducing a forming medium through spaces formed between the lateral edges of the reinforcing member and the peripheral areas of the first and second outer members in order to apply a hydraulic pressure and cause an inflating deformation of the preform, and c) forming the outer surface of the hollow section of the hydroformed product and the partition wall for substantially dividing the hollow section.

A further object of the invention is to provide a hydroformed product obtained by applying hydroforming to a preform having first and second outer members having peripheral borders overlapped and jointed, and a reinforcement member disposed between the first and second outer members. The hydroformed product includes outer surfaces of a hollow section, a partition wall and spaces. The outer surfaces which are formed by the first and second outer members have sidewalls inclined relative to an overlapping surface of the first and second outer members, and summit parts surrounded by the sidewalls. The partition wall which is formed by the reinforcement member and substantially divides the hollow section has one end and other end jointed to the summit parts of the outer surfaces according to the first and second outer members. The spaces are formed between lateral edges of the partition wall and the sidewalls of the outer surfaces.

The objects, features, and characteristics of this invention other than those set forth above will become apparent from the description given herein below with reference top referred embodiments illustrated in the accompanying drawings.

### BRIEF DESCRIPTION OF THE DRAWINGS

FIG. 1 is a perspective view of assistance in explaining a hydroformed product according to Embodiment 1.

FIG. 2 is a front view of the hydroformed product shown in FIG. 1.

FIG. 3 is a cross-sectional view taken on line III-III of FIG. 2.

FIG. 4 is a plan view of assistance in explaining an automobile part to which the hydroformed product shown in FIG. 1 is applied.

FIG. 5 is a plan view of assistance in explaining a preform according to Embodiment 1.

FIG. 6 is a rear elevation of the preform shown in FIG. 5.

FIG. 7 is a cross-sectional view taken on line VII-VII of FIG. 5.

FIG. 8 is a cross-sectional view taken on line VIII-VIII of FIG. 5.

FIG. 9 is a cross-sectional view of assistance in explaining an example of jointing method of a bottom plate, top plate, a lower insertion plate and an upper insertion plate and specifically showing the jointing process of the lower insertion plate to the bottom plate.

FIG. 10 is a cross-sectional view of assistance in explaining the jointing process of the upper insertion plate to the lower insertion plate following FIG. 9.

FIG. 11 is a cross-sectional view of assistance in explaining the jointing process of the top plate to the upper insertion plate following FIG. 10.

FIG. 12 is a cross-sectional view of assistance in explaining hydroforming apparatus according to Embodiment 1.

FIG. 13 is a plan view of assistance in explaining a top die for the hydroforming apparatus shown in FIG. 12.

FIG. 14 is a plan view of assistance in explaining a bottom die for the hydroforming apparatus shown in FIG. 12.

FIG. 15 is across-sectional view of assistance in explaining a hydroforming method according to Embodiment 1 and showing a die clamping.

FIG. 16 is a cross-sectional view showing the other end section related to FIG. 15.

FIG. 17 is a cross-sectional view of assistance in explaining an initial stage of forming continued from FIG. 16.

FIG. 18 is a cross-sectional view of assistance in explaining a die clamping continued from FIG. 17.

FIG. 19 is across-sectional view of assistance in explaining a middle stage of forming continued from FIG. 18.

FIG. 20 is a cross-sectional view of assistance in explaining a final stage of forming continued from FIG. 19.

FIG. 21 is a plan view of assistance in explaining a preform according to a first modification of Embodiment 1.

FIG. 22 is a cross-sectional view of assistance in explaining a hydroformed product according to the first modification of Embodiment 1.

FIG. 23 is a front view of assistance in explaining a second modification of Embodiment 1.

FIG. 24 is a front view of assistance in explaining a third modification of Embodiment 1.

FIG. 25 is a cross-sectional view of assistance in explaining a fourth modification of Embodiment 1.

FIG. 26 is a cross-sectional view of assistance in explaining a preform according to Embodiment 2.

FIG. 27 is a cross-sectional view of assistance in explaining shapes of a lower insertion plate and an upper insertion plate that constitute a reinforcement member of the preform shown in FIG. 26.

FIG. 28 is a cross-sectional view of assistance in explaining an example of jointing method of a bottom plate, a top plate, a lower insertion plate and an upper insertion plate and specifically showing the jointing process of the upper insertion plate to the lower insertion plate.

FIG. 29 is a cross-sectional view of assistance in explaining the jointing process of the lower insertion plate to the bottom plate following FIG. 28.

FIG. 30 is a cross-sectional view of assistance in explaining the jointing process of the top plate to the upper insertion plate following FIG. 29.

FIG. 31 is a cross-sectional view of assistance in explaining a first modification of Embodiment 2.

FIG. 32 is a plan view of assistance in explaining a preform according to Embodiment 3.

FIG. 33 is a rear elevation of the preform shown in FIG. 32.

FIG. 34 is a perspective view of assistance in explaining a hydroformed product according to Embodiment 3.

FIG. 35 is a front view of the hydroformed product shown in FIG. 34.

FIG. 36 is a cross-sectional view taken on line XXXVI-XXXVI of FIG. 35.

FIG. 37 is a cross-sectional view of assistance in explaining Embodiment 4.

### DETAILED DESCRIPTION OF THE PREFERRED EMBODIMENT

The embodiments of this invention will be described below with reference to the accompanying drawings.

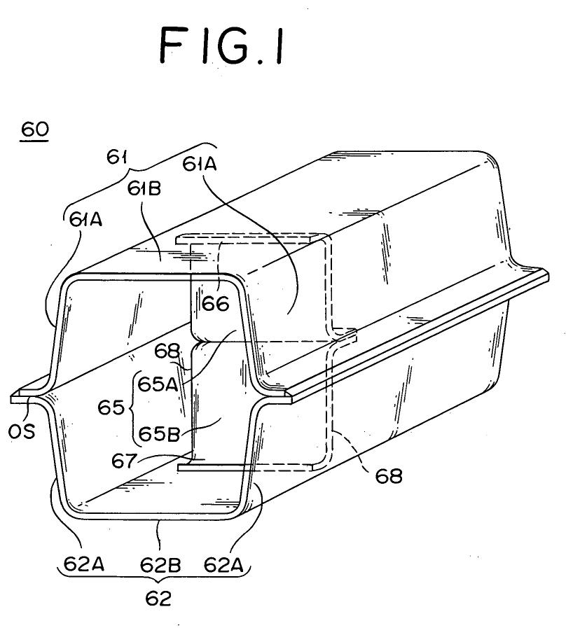

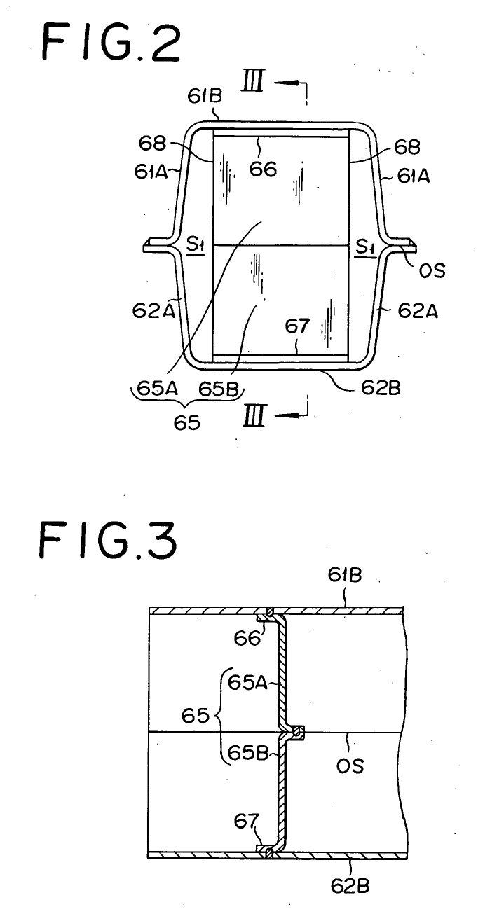

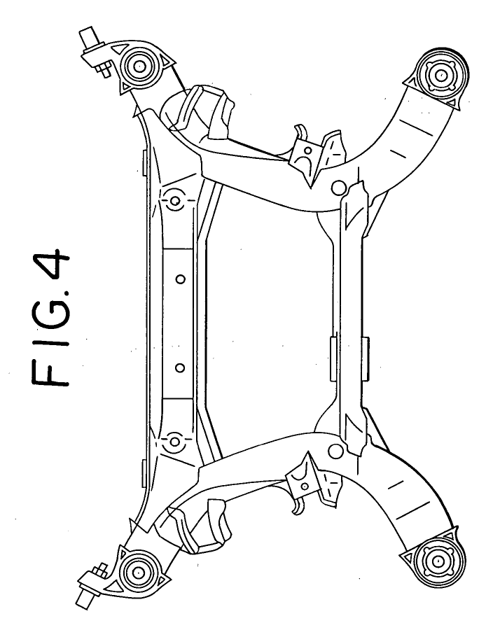

FIG. 1 is a perspective view of assistance in explaining a hydroformed product according to Embodiment 1, FIG. 2 is a front view of the hydroformed product shown in FIG. 1, FIG. 3 is a cross-sectional view taken on line III-III of FIG. 2, and FIG. 4 is a plan view of assistance in explaining an automobile part to which the hydroformed product shown in FIG. 1 is applied.

A hydroformed product 60 has outer surfaces 61, 62 forming a hollow structure and a partition wall 65, and is applicable to automobile parts that require lightweight and high rigidity characteristics such as side members and cross members of suspension parts. However, hydroformed product 60 can be applied to pillar parts, axle parts, or body side parts as well.

The outer surfaces 61, 62 have sidewalls 61A, 62A that are inclined relative to the overlapping surface OS of the outer members, and summit parts 61B, 62B surrounded by the sidewalls 61A, 62A. An upper end 66 and a lower end 67 of the partition wall 65 as one and other of ends are jointed to the summit parts 61B, 62B respectively, and the partition wall 65 thus substantially divides the hollow section of the hydroformed product 60.

The partition wall 65 is composed of first and second parts 65A and 65B which are jointed together at one end. The other ends of the first and second parts 65A, 65B constitute the upper and lower ends 66, 67 of the partition wall 65 respectively. Spaces S₁ are formed between lateral edges 68 of the partition wall 65 and the sidewalls 61A, 62A of the outer surfaces 61, 62.

Consequently, as the partition wall 65 that substantially divides the hollow section is jointed to the summit parts 61B, 62B of the outer surfaces 61, 62 at the upper and lower ends 66, 67 and thus linearly supports the hydroformed product 60 for a wide range of the hollow cross section. Therefore, it improves rigidity, particularly, rigidity relative to torsional bending. Since the areas that are supported by the partition wall 65 are the summit parts 61B, 62B, the rigidity relative to the direction perpendicular or vertical to the overlapping surface OS of the outer members is improved.

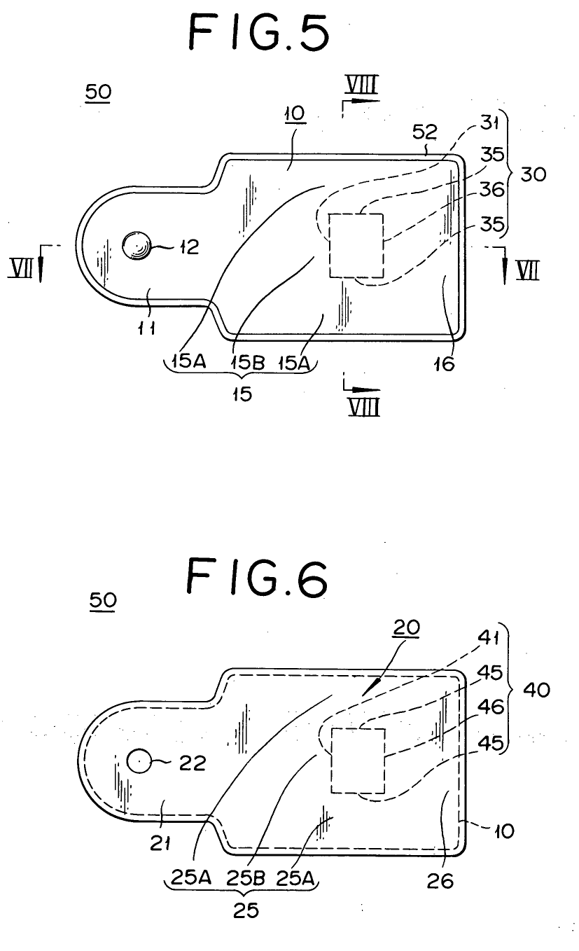

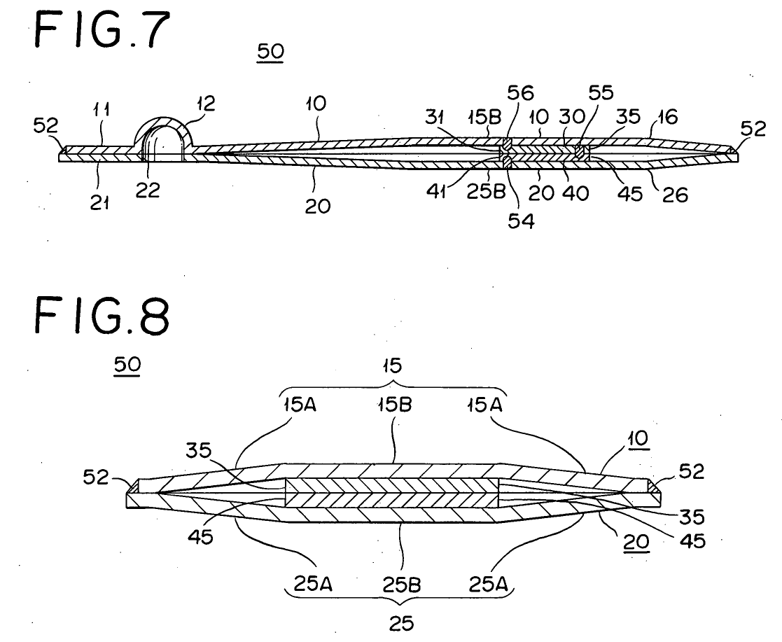

FIG. 5 is a plan view of assistance in explaining a preform according to Embodiment 1, FIG. 6 is a rear elevation of the preform shown in FIG. 5, FIG. 7 is a cross-sectional view taken on line VII-VII of the preform shown in FIG. 5, and FIG. 8 is a cross-sectional view taken on line VIII-VIII in FIG. 5.

The preform 50 has outer members and reinforcement members. The outer members are to form the outer surfaces 61, 62 of the hollow section of the hydroformed product 60. The reinforcement members are to form the partition wall 65 that substantially divides the hollow section of the hydroformed product 60.

Sheet materials that constitute the outer members consist of a top plate 10 as first outer member and a bottom plate 20 as second outer member, and their overlapped peripheral border has a joint 52 formed by fillet welding. The method of forming the joint 52 can be anything that securely provides good sealing and has no bad effect on hydraulic forming capability and, for example, laser welding, arc welding, and gluing are applicable.

Sheet materials that constitute the reinforcement members consist of an upper insertion plate 30 as first reinforcement member and a lower insertion plate 40 as second reinforcement member which have substantially similar rectangular shapes, and are overlapped each other and disposed between the top plate 10 and the bottom plate 20. The upper insertion plate 30 and the lower insertion plate 40 correspond to the first and the second parts 65A and 65B that constitute the partition wall 65 of the hydroformed product 60. The material of the sheets that constitute the outer members as the top plate 10 and the bottom plate 20, and the reinforcement members as the upper insertion plate 30 and the lower insertion plate 40 are not limited but cold rolled steel sheet and hot rolled mild steel sheet are applicable.

The top plate 10 that is to form the outer surface 61 of the hydroformed product 60 has an intermediate part 15 and end sections 11, 16 located at both sides of the intermediate part 15. Peripheral areas 15A and a middle area 15B of the intermediate part 15 constitute the sidewalls 61A and the summit part 61B of the outer surface 61. A dome-shaped part 12 is formed on the end section 11.

The bottom plate 20 that is to form the outer surface 62 of the hydroformed product 60 is slightly larger than the top plate 10 in size and is similar to the top plate 10 in shape, and has a intermediate part 25 that faces the intermediate part 15 of the top plate 10 and end sections 21, 26 that face the end sections 11, 16 of the top plate 10. Peripheral areas 25A and a middle area 25B of the intermediate part 25 constitute the sidewalls 62A and the summit part 62B of the outer surface 62. The end section 21 has an opening 22 that coincides with the position of the dome-shaped part 12.

The upper insertion plate 30 and the lower insertion plate 40 have front ends 31, 41 as one of ends facing the end sections 11, 21 of the top plate 10 and the bottom plate 20, rear end 36, 46 as the other of ends facing the end sections 16, 26 of the top plate 10 and the bottom plate 20, and lateral edges 35, 45 facing the peripheral areas 15A, 25A of the intermediate parts 15, 25 of the top plate 10 and the bottom plate 20, respectively.

The front end 31 of the upper insertion plate 30 is jointed to the middle area 15B of the top plate 10 via a joint 56. The front end 41 of the lower insertion plate 40 is jointed to the middle area 25B of the bottom plate 20 via a joint 54. The rear end 36 of the upper insertion plate 30 is jointed to the rear end 46 of the lower insertion plate 40 via a joint 55.

The lateral edges 35, 45 of the upper insertion plate 30 and the lower insertion plate 40 are not jointed and form spaces in coordination with the peripheral areas 15A, 25A of the intermediate parts 15, 25 of the top plate 10 and the bottom plate 20 for passing the forming medium during the hydroforming process.

The joints 54, 55 and 56 are formed by piercing welding. The piercing welding is preferable as it welds together the first sheet material located on the surface and the second sheet material located inside of the first sheet material to provide a good joint strength. For example, laser welding or electronic beam welding can be applied as the piercing welding. The method of forming the joints 54, 55 and 56 can be anything that securely provides good sealing and has no bad effect on hydraulic forming capability, and gluing is applicable, for example.

As described above, the upper insertion plate 30 and the lower insertion plate 40 have the front ends 31, 41 that are respectively jointed to the middle areas 15B, 25B of the top plate 10 and the bottom plate 20 that are to form the summit parts 61B, 62B of the outer surfaces 61, 62 of the hollow section of the hydroformed product 60, and the lateral edges 35, 45 that face the peripheral areas 15A, 25A of the top plate 10 and the bottom plate 20 that are to form the sidewalls 61A, 62A.

As a consequence, when hydroforming is applied to the preform 50, the forming medium flows through the spaces formed between the lateral edges 35, 45 of the upper insertion plate 30 and the lower insertion plate 40 and the peripheral areas 15A, 25A of the top plate 10 and the bottom plate 20 to apply pressure, and causes inflating deformation of the preform 50 to thus form the partition wall 65 that substantially divides the hollow section of the hydroformed product 60 from the upper insertion plate 30 and the lower insertion plate 40.

The partition wall 65 has the upper and lower ends 66, 67 jointed to the summit parts 61B, 62B of the outer surfaces 61, 62 related to the top plate 10 and the bottom plate 20, and linearly supports a wide range of the hollow cross-section of the hydroformed product 60. It is thus capable of increasing the rigidity, particularly, rigidity against torsional bending. In addition, the areas that are supported by the partition wall 65 are the summit parts 61B, 62B. Consequently, the rigidity relative to the direction perpendicular or vertical to the overlapping surface OS of the top plate 10 and the bottom plate 20 can be improved.

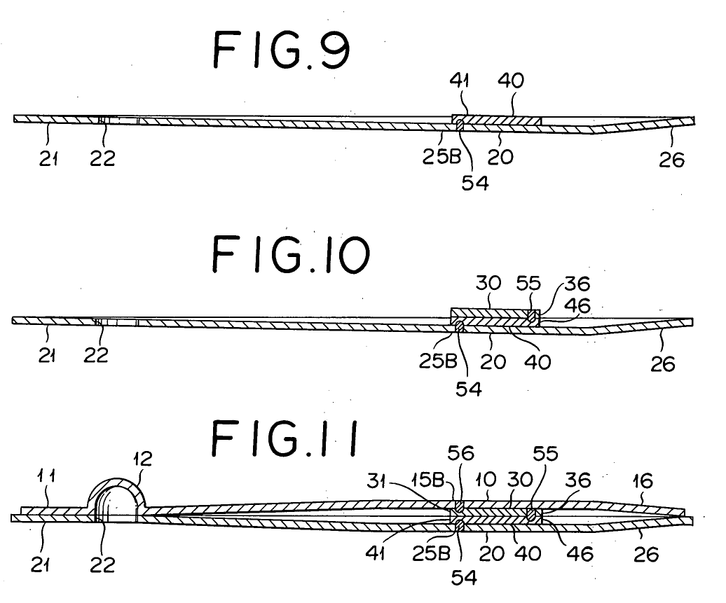

Next, an example of the jointing method of the outer members composed of the bottom plate and the top plate, and the reinforcement members composed of the lower insertion plate and the upper insertion plate of the preform will be described. FIG. 9 is a cross-sectional view of assistance in explaining the jointing process of the lower insertion plate to the bottom plate, FIG. 10 is a cross-sectional view of assistance in explaining the jointing process of the upper insertion plate to the lower insertion plate following FIG. 9, and FIG. 11 is a cross-sectional view of assistance in explaining the jointing process of the top plate to the upper insertion plate following FIG. 10.

First, the lower insertion plate 40 is placed in the middle area 25B of the intermediate part 25 of the bottom plate 20. The front end 41 of the lower insertion plate 40 is jointed to the middle area 25B of the bottom plate 20 by piercing welding to form the joint 54 (see FIG. 9).

After that, the upper insertion plate 30 is laid on the lower insertion plate 40, and the rear end 36 of the upper insertion plate 30 is jointed to the rear end 46 of the lower insertion plate 40 by piercing welding to form the joint 55 (see FIG. 10).

The top plate 10 is then laid on top of them to match the peripheral border of the top plate 10 with the peripheral border of the bottom plate 20. The middle area 15B of the intermediate part 15 of the top plate 10 is then jointed to the front end 31 of the upper insertion plate 30 to form the joint 56 (see FIG. 11).

Finally, the overlapped peripheral borders of the top plate 10 and the bottom plate 20 are jointed to complete the preform 50 (see FIG. 7).

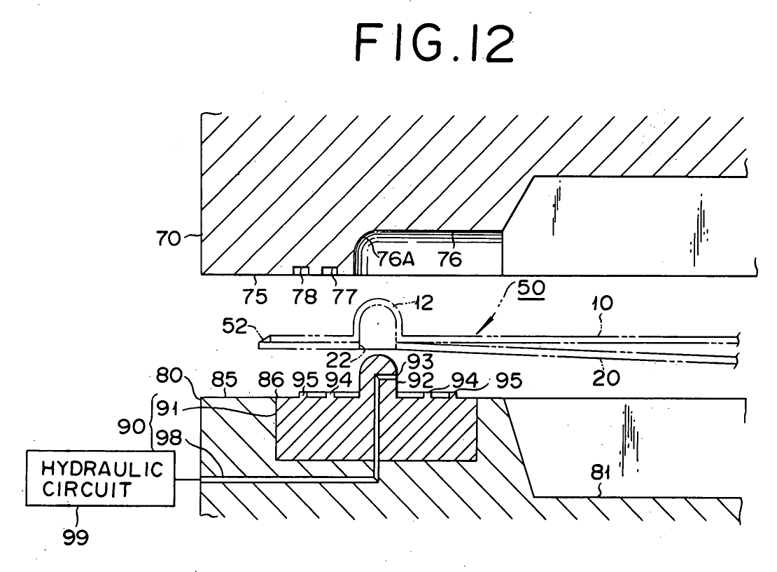

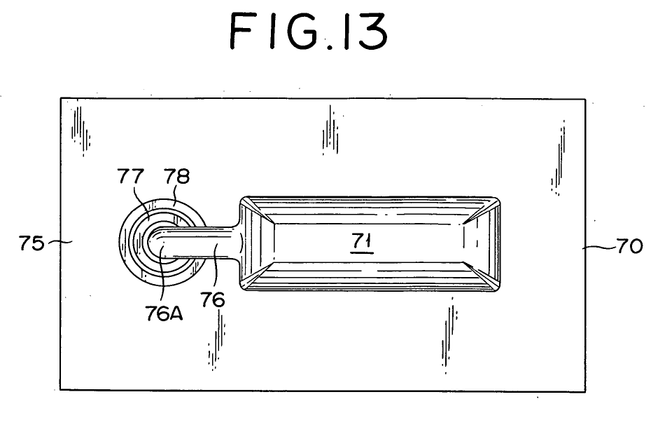

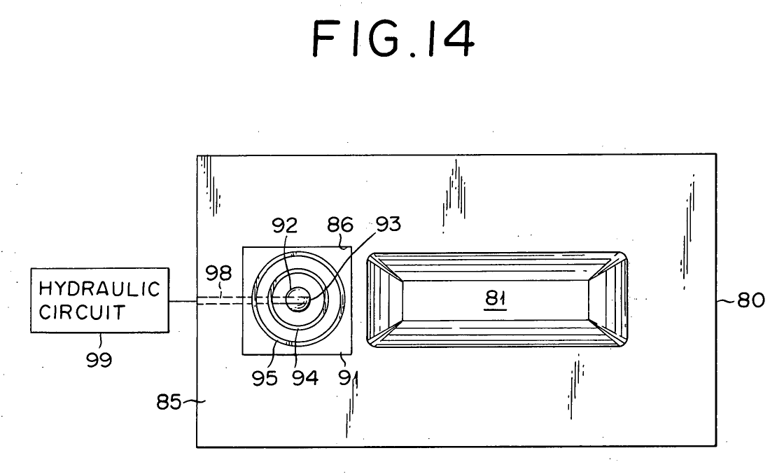

FIG. 12 is a cross-sectional view of assistance in explaining hydroforming apparatus according to Embodiment 1, FIG. 13 is a plan view of assistance in explaining a top die for the hydroforming apparatus shown in FIG. 12, and FIG. 14 is a plan view of assistance in explaining a bottom die for the hydroforming apparatus shown in FIG. 12.

The hydroforming apparatus has top and bottom dies 70, 80 as forming dies and a hydraulic pressure supply mechanism 90. The top die 70 and the bottom die 80 can be moved proximate to or apart from each other, and clamped with a preform 50 being placed inside of the top die 70 and the bottom die 80.

The top and bottom dies 70, 80 have cavity surfaces 71, 81 and pressing sections 75, 85 respectively. The cavity surfaces 71, 81 which correspond to the outer surface shapes of the hydroformed product 60 have sidewalls and summit parts as top and bottom faces that correspond to the sidewalls 61A, 62A and the summit parts 61B, 62B of the outer surfaces 61, 62 of the hollow section of the hydroformed product 60. The pressing sections 75, 85 are parts to grip the outer periphery of the preform 50 during the die clamping.

The pressing section 75 of the top die 70 includes a recess 76 that extends from the cavity surface 71, and arc-shaped grooves 77, 78 placed to surround an end part 76A of the recess 76. The end part 76A has a cross-sectional shape that corresponds to the outer shape of the section obtained by vertically separating the dome-shaped part 12 of the preform 50 in two parts. The centers of the arc-shaped grooves 77, 78 coincide with the center of the end part 76A. The pressing section 85 of the bottom die 80 has a substantially rectangular recess 86 where a nozzle unit 91 is to be placed.

The hydroforming apparatus further has a large spacer and a small spacer (not shown) placed between the pressing section 75 of the top die 70 and the pressing section 85 of the bottom die 80, so that the die clamping of the top die 70 and the bottom die 80 can be implemented in two stages.

The thickness of the larger spacer is chosen to correspond with the total thickness of the top plate 10, the bottom plate 20, the upper insertion plate 30, and the lower insertion plate 40. The thickness of the smaller space is chosen to correspond with the total thickness of the top plate 10 and the bottom plate 20.

The hydraulic pressure supply mechanism 90 which is, for example, connected to a pressure generating device having a booster cylinder and a forming medium source, has a flow path 98 and a nozzle unit 91 that are connected to a hydraulic circuit 99. The flow path 98 extends through the inside of the bottom die 80 and reaches the nozzle unit 91. The forming medium is typically water.

The nozzle unit 91 has a dome-shaped part 92 that corresponds to the inside of the dome-shaped part 12 of the preform 50, and annular protrusions 94, 95 disposed to surround the dome-shaped part 92. The annular protrusions 94, 95 are aligned with the arc-shaped grooves 77, 78 of the pressing section 75 of the top die 70. The sizes of the annular protrusions 94, 95 are smaller than the sizes of the arc-shaped grooves 77, 78 and are chosen in consideration of the thicknesses of the top plate 10 and the bottom plate 20. The arc-shaped grooves 77, 78 and the annular protrusions 94, 95 can be omitted if necessary.

The dome-shaped part 92 can pass freely through the opening 22 of the bottom plate 20 and has an injection port 93 that communicates with the flow path 98. When the nozzle unit 91 is inserted into the opening 22 and placed inside the dome-shaped part 12 of the preform 50, the forming medium supplied from the hydraulic circuit 99 is introduced inside the preform 50 via the nozzle unit 91 and the opening 22.

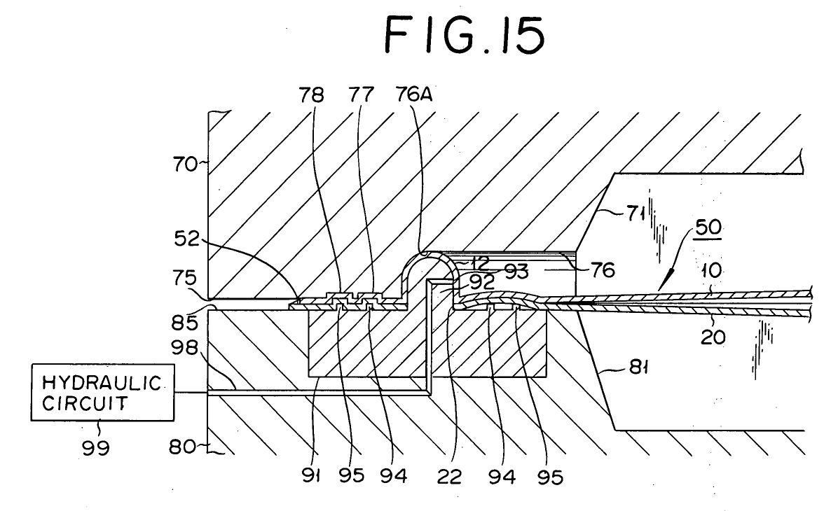

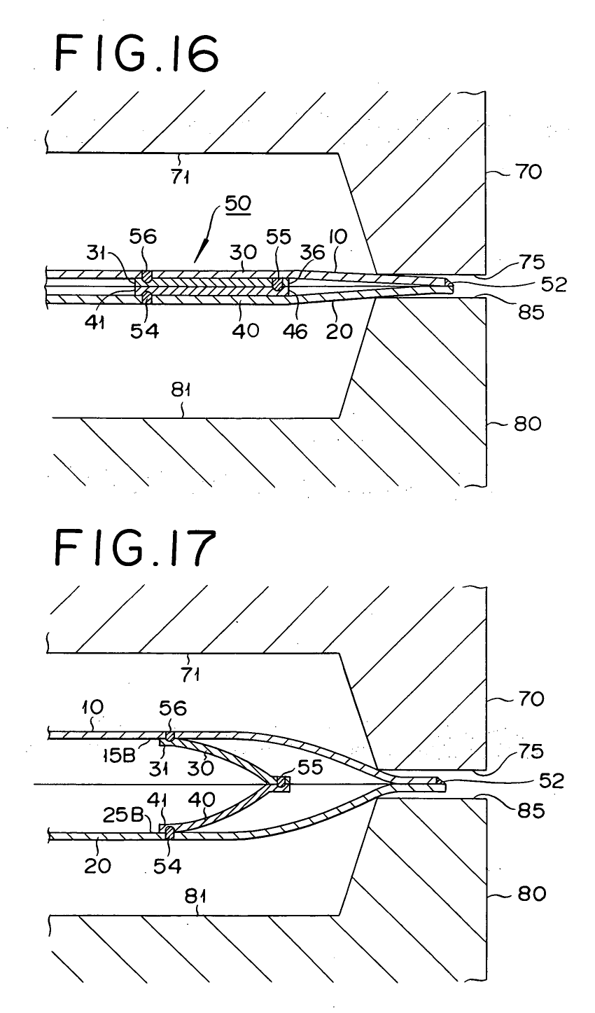

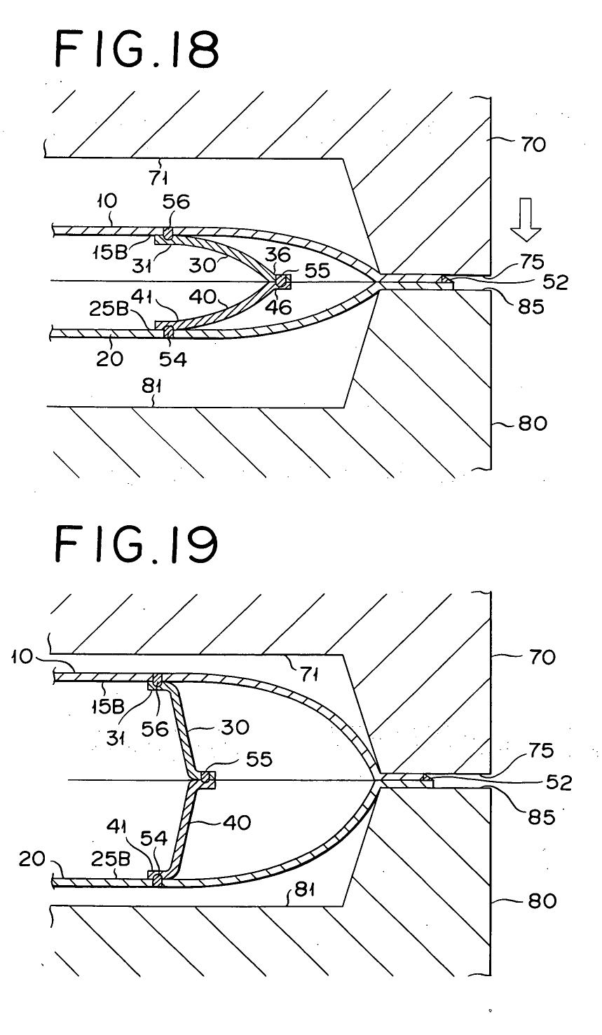

Next, the hydroforming method according to Embodiment 1 will be described. FIG. 15 is a cross-sectional view of assistance in explaining a die clamping, FIG. 16 is a cross-sectional view showing the other end section related to FIG. 15, FIG. 17 is a cross-sectional view of assistance in explaining an initial stage of forming continued from FIG. 16, FIG. 18 is a cross-sectional view of assistance in explaining a die clamping continued from FIG. 17, FIG. 19 is a cross-sectional view of assistance in explaining a middle stage of forming continued from FIG. 18, and FIG. 20 is a cross-sectional view of assistance in explaining a final stage of forming continued from FIG. 19.

First, the preform 50 is placed on the bottom die 80. At this time, the bottom plate 20 that is to constitute the outer surface 62 of the hydroformed product 60 is disposed in such a way as to face the cavity surface 81, and align the opening 22 of the bottom plate 20 with the dome-shaped part 92 of the nozzle unit 91 of the hydraulic pressure supply mechanism 90.

After that, the top die 70, which has been in a standby position, comes down to approach the bottom die 80 to complete the clamping of the top die 70 and the bottom die 80 (see FIG. 15 and FIG. 16). At this time, the top plate 10, which is to constitute the outer surface 61 of the hydroformed product 60, is disposed in such a way as to face the cavity surface 71, and the dome-shaped part 12 of the top plate 10 is fitted to the end part 76A of the recess 76 located in the pressing section 75 of the top die 70.

The vicinity of the dome-shaped part 12 is gripped by the arc-shaped grooves 77, 78 in the pressing section 75 of the top die 70 and the annular protrusions 94, 95 in the nozzle unit 91 placed in the recess 86 of the bottom die 80. This generates an annularly deformed area in the vicinity of the dome-shaped part 12, which provides an improved sealability against the forming medium being introduced. The large spacer (not shown) is place in the pressing sections 75, 85 to maintain a specified clearance.

The hydraulic pressure supply mechanism 90 introduces a forming medium supplied from the hydraulic circuit 99 into the inside of the preform 50 via the nozzle unit 91 and the opening 22. Since the lateral edges 35, 45 of the upper insertion plate 30 and the lower insertion plate 40 are not jointed, spaces are formed between the lateral edges 35, 45 and the peripheral areas 15A, 25A of the top plate 10 and the bottom plate 20. The forming medium flows into the inside of the preform 50 via the spaces to provide a hydraulic pressure.

The preform 50 consequently develops an inflating deformation, which causes the peripheral border of the preform 50 to move toward the cavity surfaces 71, 81, i.e., a material flow. Moreover, in accordance with the inflating deformation of the top plate 10 and the bottom plate 20, the front ends 31, 41 of the upper insertion plate 30 and the lower insertion plate 40 where the joints 54, 56 are located gradually separate from each other.

As the joints 54, 56 of the preform 50 move into the internal forming space surrounded by the cavity surfaces 71, 81 (see FIG. 17), the large spacer (not shown) placed between the pressing sections 75, 85 of the top die 70 and the bottom die 80 are replaced with the smaller spacer. The top die 70 comes down further in correspondence with the thickness of the smaller spacer to clamp the dies, securing a specified clearance corresponding to the thickness of the peripheral border of the preform 50 (see FIG. 18).

As the supply of the forming medium continues, the upper insertion plate 30 and the lower insertion plate 40 that are jointed to the top plate 10 and the bottom plate 20 further deform (FIG. 19). Moreover, the front ends 31, 41 of the upper insertion plate 30 and the lower insertion plate 40 are bent to be in an L-shape and the radii of curvatures of the bending parts in an L-shape become small because of the existence of the joints 54, 56.

When the inner pressure of the preform 50 reaches its final pressure, the supply of the forming medium is stopped and held for a prescribed time to complete the inflation process of the preform 50 (see FIG. 20). Consequently, the top plate 10 and the bottom plate 20 form the outer surfaces 61, 62 of the hollow section of the hydroformed product 60. Specifically, the peripheral areas 15A, 25A and the middle areas 15B, 25B of the intermediate parts 15, 25 of the top plate 10 and the bottom plate 20 form the sidewalls 61A, 62A that are inclined relative to the overlapping surface OS of the outer surfaces 61, 62 and the summit parts 61B, 62B surrounded by the sidewalls 61A, 62A.

On the other hand, the upper insertion plate 30 and the lower insertion plate 40 form the partition wall 65 (65A and 65B) that divides the hollow section of the hydroformed product 60. Specifically, the front ends 31, 41 of the upper insertion plate 30 and the lower insertion plate 40 form the upper and lower ends 66, 67 of the partition wall 65. Since the upper and lower ends 66, 67 are jointed to the summit parts 61B, 62B of the outer surfaces related to the top plate 10 and the bottom plate 20, the partition wall 65 linearly supports a wide range of the hollow cross-section of the hydroformed product 60 to improve the rigidity, particularly, rigidity against torsional bending. Since the areas that are supported by the partition wall 65 are the summit parts 61B, 62B, the rigidity relative to the direction perpendicular or vertical to the overlapping surface OS of the top plate 10 and the bottom plate 20 can be improved.

Then, after reducing the pressure and discharging the forming medium, the top die 70 is raised to open the dies, the hydroformed product 60 is removed, and trimming and cutoff are executed on the hydroformed product 60. It is also preferable to expedite the discharge of the forming medium more quickly by providing a movable punch or male die on the forming dies of the top die 70 and bottom die 80 to form an opening at a proper location of the hydroformed product 60 when discharging the forming medium.

The first embodiment can provide a preform for hydroforming capable of improving the rigidity relative to torsional bending and rigidity in the vertical direction of a hydroformed product, a hydroforming method for manufacturing a hydroformed product with the excellent rigidity relative to torsional bending and rigidity in the vertical direction, and a hydroformed product with the excellent rigidity relative to torsional bending and rigidity in the vertical direction.

Moreover, although it was shown to provide the hydraulic pressure by injecting the forming medium through the opening formed in one of the outer members, Embodiment 1 is capable of applying various other types of preforms and hydroforming apparatuses without being limited to the aforementioned particular style.

For example, the opening 22 of the bottom plate 20 and the nozzle unit 91 of the hydraulic pressure supply mechanism 90 can both be provided more than one. It is also possible to perform the die clamping only once by disposing the joints 54, 56 of the preform 50 in the internal forming space surrounded by the cavity surfaces 71, 81 from the start, and to eliminate the spacer replacement process.

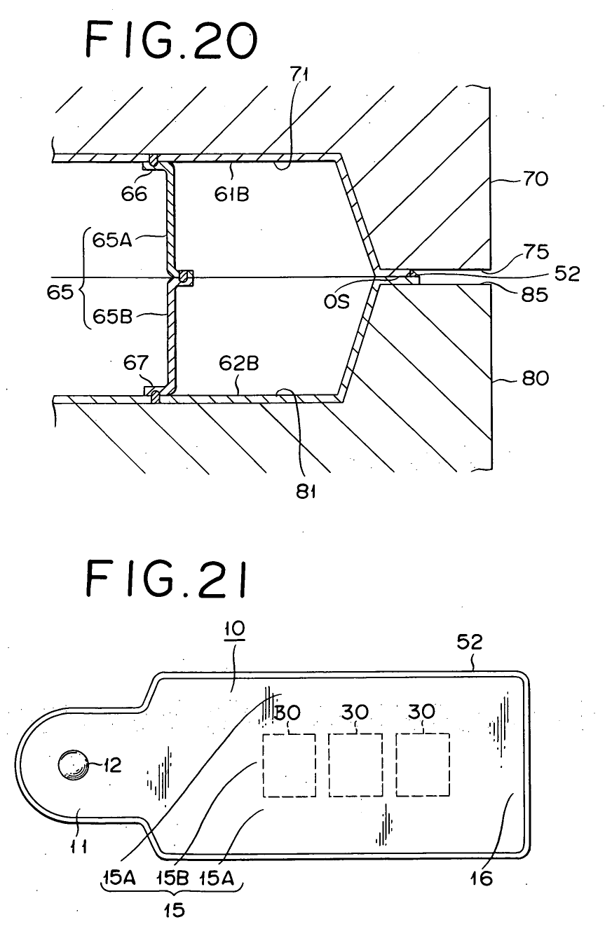

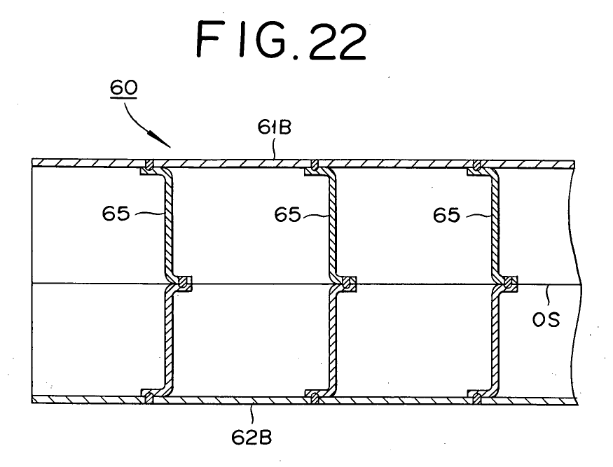

Also, it is possible to repeatedly dispose a pair of the upper insertion plates 30 and the lower insertion plates 40 that constitute the reinforcement members at proper intervals as in a first modification shown in FIG. 21. In this case, a plurality of the partition walls 65 that substantially divide the hollow section of the hydroformed product 60 are formed in parallel as shown in FIG. 22.

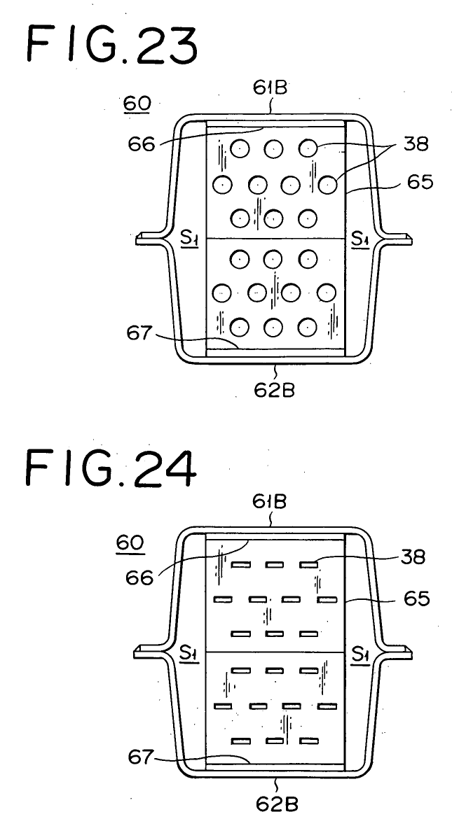

It is preferable to reduce the weight of the hydroformed product 60 by forming circular or slit-like openings 38 on the partition wall 65 of the hydroformed product 60 as a second modification or a third modification shown in FIG. 23 and FIG. 24. This is made possible by forming openings corresponding to the openings 38 on the upper insertion plate 30 and the lower insertion plate 40 constituting the reinforcement members.

The openings 38 are preferably disposed in a non-joint area in order to avoid effects on the strength of the joints 54, 55, and 56 of the upper insertion plate 30 and the lower insertion plate 40. It is also preferable that the openings 38 is so aligned as to face toward the injection port 93 of the nozzle unit 91 for introducing the forming medium during the inflating deformation in order to promote the flow of the forming medium.

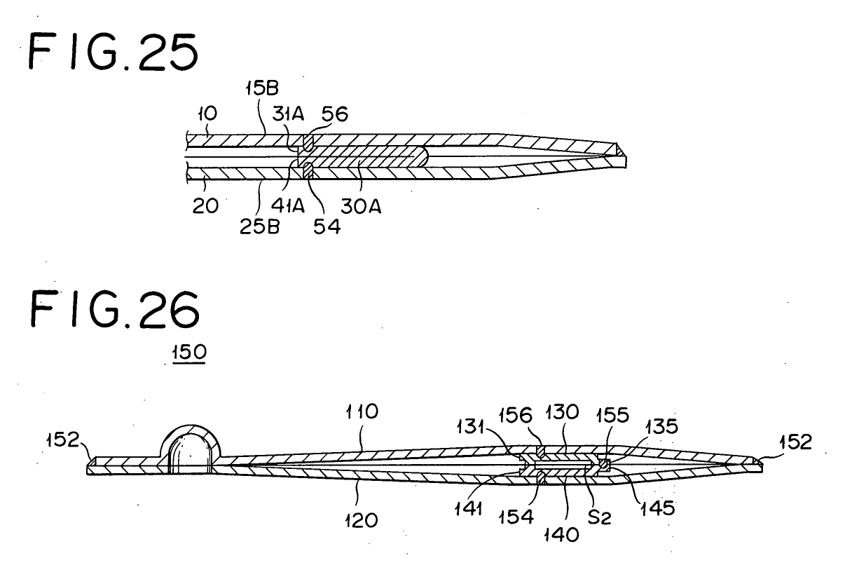

It is also possible to constitute a reinforcement member with a single sheet material 30A having a bent shape as shown as a fourth modification in FIG. 25. In this case one front end 31A of the sheet material 30A is jointed to the middle area 15B of the top plate 10 via a joint 56 and the other front end 41A of the sheet material 30A is jointed to the middle area 25B of the bottom plate 20 via a joint 54. The bent part of the sheet material 30A corresponds to the joint 55 between the upper insertion plate 30 and the lower insertion plate 40.

FIG. 26 is a cross-sectional view of a preform according to Embodiment 2 and FIG. 27 is a cross-sectional view of assistance in explaining shapes of a lower insertion plate and an upper insertion plate that constitute reinforcement members of a preform shown in FIG. 26. Those members that have the same functions as those in Embodiment 1 will be denoted hereinafter with the similar reference numerals in order to avoid duplicating their descriptions.

The Embodiment 2 is generally different from Embodiment 1 in that the miswelding is prevented by modifying the shapes of the upper insertion plate and the lower insertion plate.

The upper insertion plate 130 and the lower insertion plate 140 according to Embodiment 2 have protrusions 132, 136, 142, 146 disposed on front ends 131, 141 as one of ends and rear ends 135, 145 as the other of ends, on the sides which face each other. Since the protrusions 132, 136, 142, 146 are formed by the pressing, the back areas 133, 137, 143, 147 are recesses in bending shapes. The protrusions 132, 136, 142, 146 are not necessarily be formed by the pressing.

The lower insertion plate 140 is disposed in such a way that the back areas 143, 147 of the protrusions 142, 146 face the bottom plate 120 while the front end 141 of the lower insertion plate 140 is connected to the middle area of the bottom plate 120 via the joint 154.

The upper insertion plate 130 is disposed in such a way that the protrusions 132, 136 face the protrusions 142, 146 of the lower insertion plate 140 while the rear end 135 of the upper insertion plate 130 is connected to the rear end 145 of the lower insertion plate 140 via the joint 155. The protrusions 132, 136 of the upper insertion plate 130 and the protrusions 142, 146 of the lower insertion plate 140 jointly form a substantially rectangular space S₂.

The top plate 110 is so disposed as to face the back areas 133, 137 of the protrusions 132, 136 of the upper insertion plate 130 while the middle area of the top plate 110 is connected to the front end 131 of the upper insertion plate 130 via the joint 156.

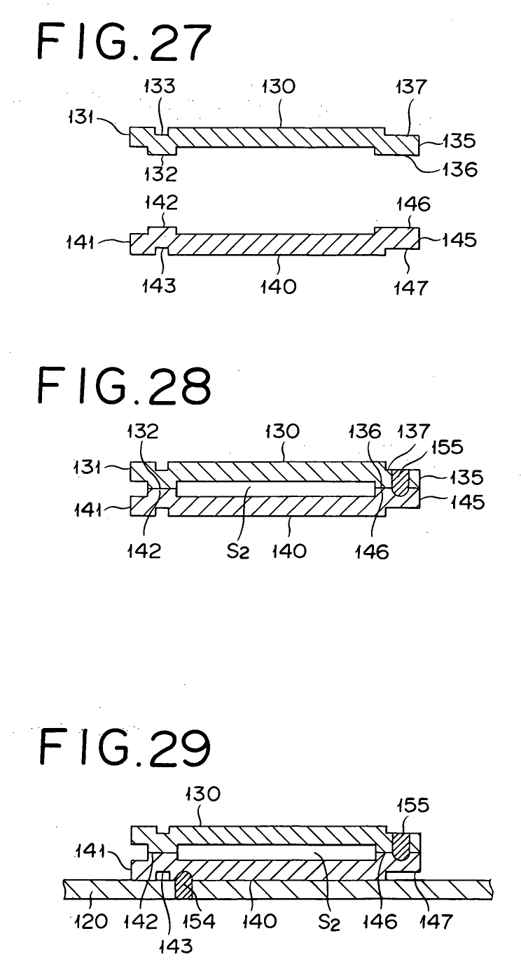

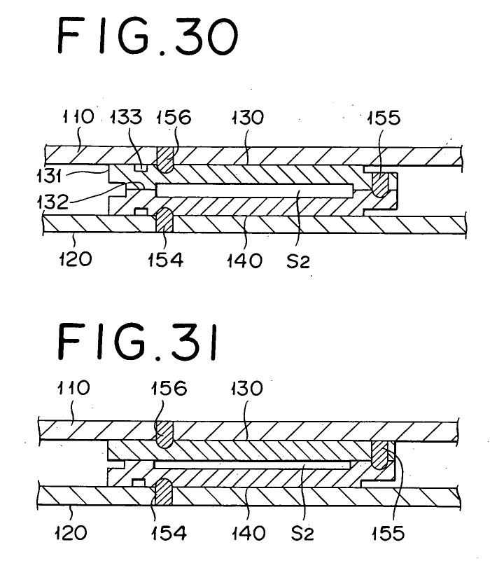

Next, an example of the jointing method of the top plate, the bottom plate, the upper insertion plate 130 and the lower insertion plate 140 will be described. FIG. 28 is a cross-sectional view of assistance in explaining the jointing process of the lower insertion plate to the upper insertion plate, FIG. 29 is a cross-sectional view of assistance in explaining the jointing process of the lower insertion plate to the bottom plate following FIG. 28, and FIG. 30 is a cross-sectional view of assistance in explaining the jointing process of the top plate to the upper insertion plate following FIG. 29.

First, place the upper insertion plate 130 on the lower insertion plate 140 and align them with each other, make the protrusions 132, 136 of the upper insertion plate 130 abut against the protrusions 142, 146 of the upper insertion plate 140 to form a substantially rectangular space S₂. Joint the protrusion 136 of the upper insertion plate 130 with the protrusion 146 of the lower insertion plate 140 by applying piercing welding from the back area 137 of the protrusion 136 of the upper insertion plate 130 to form the joint 155 (see FIG. 28).

After that, place the lower insertion plate 140 in such a way that the back areas 143, 147 of the protrusions 142, 146 face the middle area of the bottom plate 120, which is placed in the specified position. Then, joint an area, which faces the space S₂ and is adjacent to the back area 143 of the protrusion 142 of the lower insertion plate 140, to the middle area of the bottom plate 120 to form the joint 154 by applying piercing welding from the bottom plate 120 (see FIG. 29).

The joint 154 is formed by welding the bottom plate 120 as the first sheet material located on the surface to the lower insertion plate 140 as the second sheet material located inside of the first sheet material while stacking more than three pieces of sheet materials that constitute the outer member and the reinforcement members, i.e., the bottom plate 120, and the upper insertion plate 130 and the lower insertion plate 140.

During the welding, there is the space S₂, which is aligned with the joint area and located between the second sheet material or the lower insertion plate 140 and the third sheet material or the upper insertion plate 130 located in the inside of the second sheet material. The space S₂ therefore prevents the transmission of welding heat and inadvertent miswelding of the second sheet material or the lower insertion plate 140 to the third sheet material or the upper insertion plate 130, and minimizes the possibility of fracture of the joint 154 due to welding failures to improve the welding yield.

When the formation of the joint 154 is completed, the top plate 110 is laid matching the peripheral border of the top plate 110 with the peripheral border of the bottom plate 120. Then, joint an area, which faces the space S₂ and is adjacent to the back area 133 of the protrusion 132 of the upper insertion plate 130, to the middle area of the top plate 110 to form the joint 156 by applying piercing welding from the top plate 110 (see FIG. 30).

The joint 156 is formed by welding the top plate 110 as the first sheet material located on the surface to the upper insertion plate 130 as the second sheet material located inside of the first sheet material while stacking more than three pieces of sheet materials that constitute the outer members and the reinforcement members, i.e., the top plate 110, the bottom plate 120, the upper insertion plate 130 and lower insertion plate 140.

During the welding, there is the space S₂, which is aligned with the joint area and is located between the second sheet material or the upper insertion plate 130 and the third sheet material or the lower insertion plate 140 located in the inside of the second sheet material. The space S₂ therefore prevents the transmission of welding heat and inadvertent miswelding of the second sheet material or the upper insertion plate 130 to the third sheet material or the lower insertion plate 140, and minimizes the possibility of fracture of the joint 154 due to welding failures to improve the welding yield.

When the forming of the joint 156 is completed, the overlapped peripheral borders of the top plate 110 and the bottom plate 120 are jointed, for example, by fillet welding to form the joint 152 and then the preform 150 is obtained (see FIG. 26).

As stated above, the miswelding of the preform 150 according to Embodiment 2 is prevented. This improves the quality of welding joints and can minimize the possibility of fractures of the welding joints. Also, it reduces the manufacturing cost of the preform due to the improvement of the welding yield.

It is possible to make one of the upper insertion plate 130 and the lower insertion plate 140, for example, the upper insertion plate 130 flat as a first modification shown in FIG. 31. It is also possible to fittingly combine the first through fourth modifications of Embodiment 1 with Embodiment 2.

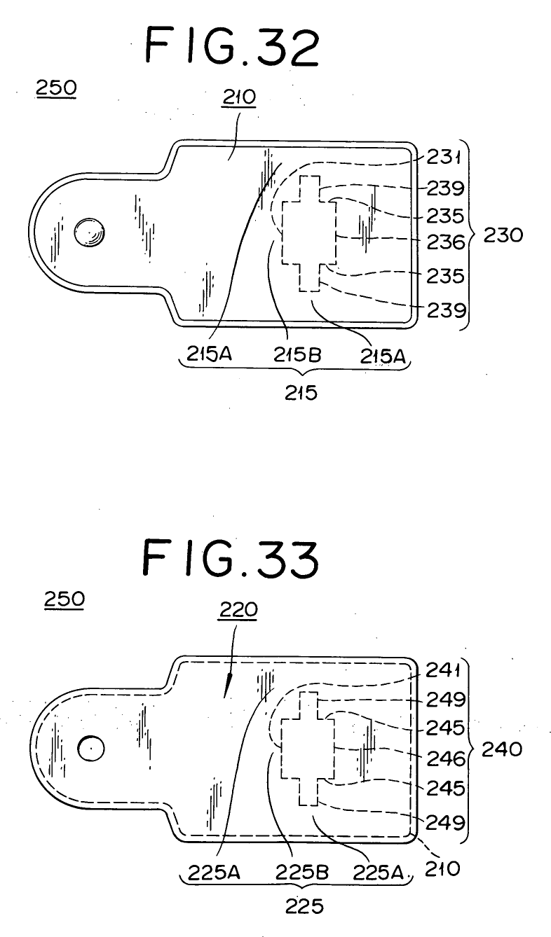

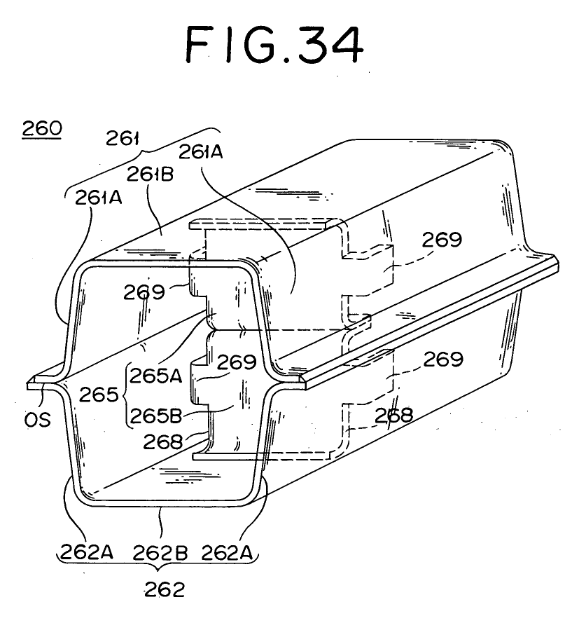

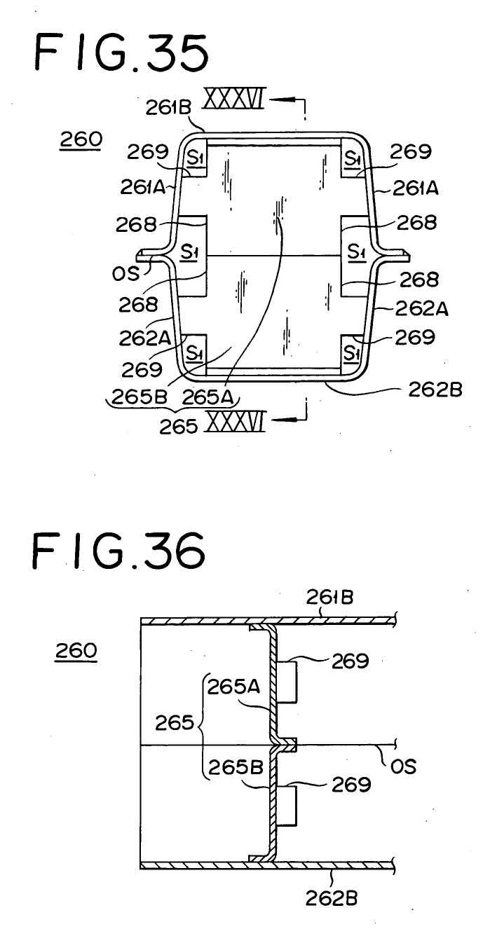

FIG. 32 and FIG. 33 are a plan view and a rear elevation of assistance in explaining a preform according to Embodiment 3, FIG. 34 is a perspective view of assistance in explaining a hydroformed product according to Embodiment 3, FIG. 35 is a front view of the hydroformed product shown in FIG. 34, and FIG. 36 is a cross-sectional view taken on line XXXVI-XXXVI of FIG. 35.

Embodiment 3 is substantially different from Embodiment in the fact that the shapes of the upper insertion plate and the lower insertion plate are modified in order to improve the rigidity in the direction parallel or horizontal to the overlapping surface of the outer members.

The upper insertion plate 230 and the lower insertion plate 240 according to Embodiment 3 have extensions 239, 249 protruding sideways from the lateral edges 235, 245. The sizes of the extensions 239, 249 are chosen in such a way that the peripheral areas 215A, 225A of the intermediate parts of the top plate 210 and the bottom plate 220 abuts against the extensions 239, 249 to cause bending of the extensions 239, 249.

Consequently, when hydroforming is applied to the preform 250, the top plate 210 and the bottom plate 220 form the outer surfaces 261, 262 of the hollow section of the hydroformed product 60, the peripheral areas 215A, 225A and the middle areas 215B, 225B of the intermediate parts 215, 225 of the top plate 210 and the bottom plate 220 form the sidewalls 261A, 262A that are inclined relative to the overlapping surface OS of the outer surfaces 261, 262 and the summit parts 261B, 262B surrounded by the sidewalls 261A, 262A.

On the other hand, the upper insertion plate 230 and the lower insertion plate 240 form the partition wall 265 (265A, 265B) that divides the hollow section of the hydroformed product 260. The partition wall 265 (265A and 265B) has extensions 269 that protrude sideways from the lateral edges 268. The extensions 269 are bent and abut with sidewalls 261A, 262A of the hydroformed product 260. In other words, the extensions 269 of the partition wall 265 (265A, 265B) support the sidewalls 261A, 262A of the hydroformed product 260 and thus improve the rigidity in the direction parallel or horizontal direction to the overlapping surface OS.

As can be seen from the above, Embodiment 3 can improve the rigidity in the direction parallel or horizontal to the overlapping surface of the outer members.

The sizes of the extensions 239, 249 can be chosen not to cause them to contact with the peripheral areas 215A, 225A of the intermediate parts of the top plate 210 and the bottom plate 220 in hydroforming, but can be adjusted so that the extensions 269 of the partition wall 265 (265A, 265B) can be positioned close to the sidewalls 216A, 262A of the hydroformed product 260. If a load is applied due to a certain cause and the hollow section of the hydroformed product 260 deforms, the extensions 269 abut against the sidewalls 261A, 262A and prevent excessive deformation in this case. It is also possible to combine Embodiment 1, first through fourth modifications of Embodiment 1, Embodiment 2 and first modification of Embodiment 2 suitably with Embodiment 3.

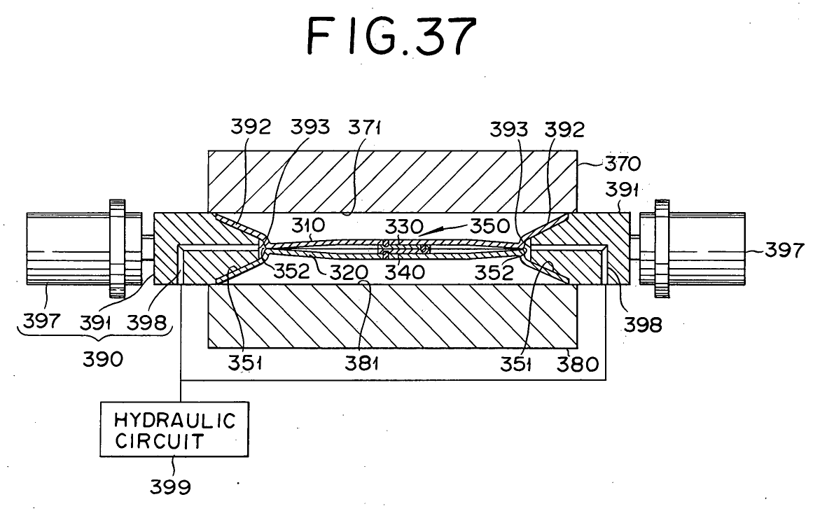

FIG. 37 is a cross-sectional view of assistance in explaining Embodiment 4. Embodiment 4 is generally different from Embodiment 1 concerning the shape of the preform and the constitution of the hydroforming apparatus.

More specifically, a preform 350 according to Embodiment 4 has a top plate 310 and a bottom plate 320 that are to form outer surfaces of a hydroformed product, an upper insertion plate 330 and a lower insertion plate 340 that are to form reinforcing ribs, and a non-jointing part 351 for introducing forming medium to provide a hydraulic pressure.

The upper insertion plate 330 and the lower insertion plate 340 are disposed between the top plate 310 and the bottom plate 320. The non-jointing part 351 is formed by an abutting area of end faces of the top plate 310 and the bottom plate 320, which is preformed in substantially a conical shape. The non-jointing part 351 has an outer end on which a circular opening is provided and an inner end 352 communicating with the inside of the preform 350. In other words, the preform 350 has an opening formed by the abutting area of the end face of one of the outer members 310, 320 and the end face of the other of the outer members 310, 320. The non-jointing part 351 is not limited to a shape being disposed throughout the end face but can be partially disposed.

The top plate 310 is disposed to face a cavity surface 371 of a top die 370. The bottom plate 320 is disposed to face a cavity surface 381 of a bottom die 380. The cavity surfaces 371, 381 correspond to the outer surface shapes of the hydroformed product.

A hydraulic pressure supply mechanism 390 has a flow path 398 that communicates with a hydraulic circuit 399, axial press punches 391, and axial press cylinders 397. The axial press punches 391 are located on sides of the top die 370 and the bottom die 380 and connected to the axial press cylinders 397, respectively. The axial press punch 391 has a nozzle unit 392.

The nozzle unit 392 has an injection port 393 that communicates with the flow path 398, and presents a substantially conical shape that corresponds with the shape of the non-jointing part 351. The axial press cylinder 397 supports the axial press punch 391 to move towards or away from the forming dies, the top die 370 and the bottom die 380. The power source of the axial press cylinder 397 is typically hydraulic or pneumatic.

The non-jointing part 351 of the preform 350 expands when the nozzle unit 392 is pushed into its opening, while its expanded diameter is restricted by the top die 370 and the bottom die 380. As a consequence, the non-jointing part 351 makes a close contact with the nozzle unit 392 providing a sealing effect.

The injection port 393 of the nozzle unit 392 is aligned with the inner end 352 that communicates with the inside of the preform 350. As a consequence, the forming medium which is supplied from the hydraulic circuit 399 and introduced to the flow path 398 and the injection port 393, is injected into the inside of the preform 350 via the non-jointing part 351 and the inner end 352.

Therefore, the hydraulic pressure supply mechanism 390 applies a hydraulic pressure to the inside of the preform 350 to cause an inflating deformation.

As can be seen from the above, Embodiment 4 can form the outer surfaces of a hydroformed product and a partition wall that divides the hollow cross section of the hydroformed product by means of introducing a forming medium into an opening created by the abutting area of the end face of one of the outer members 310, 320 and the end face of the other of the outer members 310, 320 to apply hydraulic pressure to the preform 350, and causing an inflating deformation of the preform 350.

It is obvious that this invention is not limited to the particular embodiments shown and described above but may be variously changed and modified without departing from the technical concept of this invention.

For example, depending on intended hydroformed product, it is possible to modify as needed the shapes of the sheet materials that constitute the first and second outer members, the shapes of the sheet materials that constitute the reinforcement members, positions of the protrusions, and the relative arrangement of the sheet materials that constitute the reinforcement members inside the preform.

This application is based on Japanese Patent Application No. 2004-316599 filed on Oct. 29, 2004, the contents of which are hereby incorporated by reference.

What is claimed is:

1. A preform comprising:
first and second outer members having peripheral borders overlapped and jointed for forming outer surfaces of a hollow section of a hydroformed product; and
a reinforcement member disposed between said first and second outer members for forming a partition wall that substantially divides the hollow section,
in which said outer members have sidewalls inclined relative to an overlapping surface of said first and second outer members, and summit parts surrounded by said sidewalls,
in which said reinforcement member has one and other ends jointed to areas which are to form said summit parts of said first and second outer members, and lateral edges which face peripheral areas of said first and second outer members which are to form said sidewalls.

2. A preform as claimed in claim 1, in which said reinforcement member has an opening.

3. A preform as claimed in claim 2, in which said opening is formed like a circular.

4. A preform as claimed in claim 2, in which said opening is formed like a slit.

5. A preform as claimed in claim 2, in which said opening is disposed in a non-joint area.

6. A preform as claimed in claim 2, in which said opening is so aligned as to face toward an injection port of a nozzle unit for introducing a forming medium during an inflating deformation.

7. A preform as claimed in claim 1, in which said reinforcement member is composed of first and second reinforcement members disposed to be overlapped on each other,
in which one ends of said first and second reinforcement members are jointed together, and other ends of said first and second reinforcement members form said ends jointed to the areas which are to form said summit parts of said first and second outer members, respectively.

8. A preform as claimed in claim 7, in which said first and second reinforcement members have extensions which protrude sideways from said lateral edges.

9. A preform as claimed in claim 8, in which sizes of said extensions are chosen in such a way that said extensions abut against the peripheral areas of said first and second outer members and thus are bent during hydroforming.

10. A preform as claimed in claim 1, further comprising a joint formed by, when stacking more than three pieces of sheet materials that constitute said outer members and said reinforcement member, welding a first sheet material located on a surface to a second sheet material located inside of said first sheet material, and a space which is aligned with a joint area and located between said second sheet material and a third sheet material located in the inside of said second sheet material.

11. A preform as claimed in claim 10, in which said second sheet material and/or said third sheet material has a protrusion on a confronting surface so that said space is formed by abutting of said protrusion.

12. A preform as claimed in claim 11, in which a recess is formed on a back area of said protrusion.

13. A preform as claimed in claim 12, in which said recess has a bent shape.

14. A hydraulic forming method which comprises:
a) disposing a preform inside forming dies having cavity surfaces which correspond to outer surface shapes of a hydroformed product, said preform comprising first and second outer members having peripheral borders overlapped and jointed for forming outer surfaces of a hollow section of a hydroformed product, and a reinforcement member disposed between said first and second outer members for forming a partition wall that substantially divides the hollow section, in which said outer members have sidewalls inclined relative to an overlapping surface of said first and second outer members, and summit parts surrounded by said sidewalls, in which said reinforcement member has one and other ends jointed to areas which are to form said summit parts of said first and second outer members, and lateral edges which face peripheral areas of said first and second outer members which are to form said sidewalls;
b) introducing a forming medium through spaces formed between the lateral edges of said reinforcing member and the peripheral areas of said first and second outer members in order to apply a hydraulic pressure and cause an inflating deformation of said preform; and
c) forming the outer surface of the hollow section of the hydroformed product and the partition wall for substantially dividing said hollow section.

15. A hydroforming method as claimed in claim 14, in which said reinforcement member has an opening which is so aligned as to face toward an injection port of a nozzle unit for introducing a forming medium during an inflating deformation in which said forming medium is caused to flow through said opening.

16. A hydroforming method as claimed in claim 14, in which said reinforcement member is composed of first and second reinforcement members disposed to be overlapped on each other,
in which one ends of said first and second reinforcement members are jointed together, and other ends of said first and second reinforcement members form said ends jointed to the areas which are to form said summit parts of said first and second outer members, respectively,
in which said first and second reinforcement members have extensions which protrude sideways from said lateral edges,
in which said extensions are caused to abut against the peripheral areas of said first and second outer members and to be bent during hydroforming.

17. A hydroforming method as claimed in claim 14, in which a nozzle unit for introducing the forming medium is inserted into an opening formed in one of said first and second outer member.

18. A hydroforming method as claimed in claim 14, in which a nozzle unit for introducing the forming medium is inserted into an opening formed by an abutting area of end faces of said first outer member and said second outer member.

19. A hydroformed product obtained by applying hydroforming to a preform having first and second outer members having peripheral borders overlapped and jointed, and a reinforcement member disposed between said first and second outer members, said hydroformed product comprising:
outer surfaces of a hollow section, which are formed by said first and second outer members, having sidewalls inclined relative to an overlapping surface of said first and second outer members, and summit parts surrounded by said sidewalls;
a partition wall, which are formed by said reinforcement member and substantially divides the hollow section, having one end and other end jointed to the summit parts of said outer surfaces according to said first and second outer members; and
spaces which are formed between lateral edges of said partition wall and the sidewalls of said outer surfaces.

20. A hydroformed product as claimed in claim 19, in which said partition wall has an opening.

21. A hydroformed product as claimed in claim 20, in which said opening is formed like circular.

22. A hydroformed product as claimed in claim 20, in which said opening is formed like a slit.

23. A hydroformed product as claimed in claim 20, in which said opening is disposed in a non-joint area.

24. A hydroformed product claimed in claim 19, in which said partition wall is formed of first and second parts which are jointed together at one end, in which other ends of the first and second parts constitute said one end and said other end of said partition wall which are jointed to the summit parts of said outer surfaces according to said first and second outer members, respectively.

25. A hydroformed product as claimed in claim 24, in which said first and second parts have extensions which protrude sideways from said lateral edges.

26. A hydroformed product as claimed in claim 25, in which said extensions are bent as a result of abutting against said sidewalls of the outer surfaces of said hollow section.

27. A hydroformed product claimed in claim 24, in which said one ends of the first and second parts are jointed to form a joint by welding.

28. A hydroformed product as claimed in claim 27, in which said one ends of the first and second parts have protrusions formed on sides which face each other, said protrusions located close to said joint.

29. A hydroformed product as claimed in claim 28, in which a recess is formed on a back area of said protrusion.

30. A hydroformed product as claimed in claim 29, in which said recess has a bent shape.

31. A hydroformed product as claimed in claim 19, in which said hydroformed product is used as an automobile body structural member.

32. A hydroformed product as claimed in claim 31, in which said automobile body structural member is a suspension part.
